(19) United States
(12) Patent Application Publication
(10) Pub. No.: US 2024/0113387 A1
(43) Pub. Date: Apr. 4, 2024

(54) SYSTEMS AND METHODS FOR REDUCING TURBULENT COMBUSTION

(71) Applicant: Rivian IP Holdings, LLC, Plymouth, MI (US)

(72) Inventors: Jinyong Kim, San Jose, CA (US); Ki Woon Kim, Milpitas, CA (US); Sun Ung Kim, Pleasanton, CA (US); Yunki Baik, San Jose, CA (US); Sanket Sudam Mundhe, Fremont, CA (US); Asma Sharafi, Foster City, CA (US)

(73) Assignee: Rivian IP Holdings, LLC, Plymouth, MI (US)

(21) Appl. No.: 17/957,645

(22) Filed: Sep. 30, 2022

(51) Int. Cl. H01M 50/30

(52) U.S. Cl. CPC H01M 50/394; H01M 2220/20

(57) ABSTRACT

Provided herein is an apparatus. The apparatus can include a battery cell. The battery cell can include a vent. The vent can be coupled with the battery cell. The apparatus can include a channel coupled with the vent. The apparatus can include a porous component. The porous component can be disposed in the channel. The porous component can include one or more pores each having a width less than a width of the channel.

### INTRODUCTION

Batteries can have different power capacities to charge and discharge power to operate machines.

### SUMMARY

Combustible gas vented from a battery cell can have high temperatures when they are released from the battery cell and can ignite when they mix with the air. The solutions described herein can reduce the rate of turbulent combustion by providing a porous component disposed in the channel that reduces the turbulent mass diffusivity of the gas released from the battery cell.

At least one aspect is directed to an apparatus. The apparatus can include a battery cell. The battery cell can include a vent. The vent can be coupled with the battery cell. The apparatus can include a channel coupled with the vent. The apparatus can include a porous component. The porous component can be disposed in the channel. The porous component can include one or more pores each having a width less than a width of the channel.

At least one aspect is directed to a method. The method can include coupling a vent with a battery cell. The method can include coupling a channel with the vent. The method can include disposing a porous component in the channel. The porous component can include one or more pores each having a width less than a width of the channel.

At least one aspect is directed to an electric vehicle. The electric vehicle can include a battery cell. The battery cell can include a vent. The electric vehicle can include a channel coupled with the vent. The electric vehicle can include a porous component disposed in the channel. The porous component can include one or more pores each having a width less than a width of the channel.

At least one aspect is directed to a system. The system can include a battery cell. The battery cell can include a vent coupled with the battery cell. The system can include a channel coupled with the vent. The system can include a porous component disposed in the channel. The porous component can include one or more pores each having a width less than a width of the channel.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a cross-sectional view of an electric vehicle, according to an example implementation.

FIG. 2A depicts a battery pack, according to an example implementation.

FIG. 2B depicts a battery module, according to an example implementation.

FIG. 2C depicts a cross-sectional view of a battery cell, according to an example implementation.

FIG. 2D depicts a cross-sectional view of a battery cell, according to an example implementation.

FIG. 2E depicts a cross-sectional view of a battery cell, according to an example implementation.

FIG. 3 depicts a perspective view of an apparatus, according to an example implementation.

FIG. 4 depicts a perspective view of an apparatus, according to an example implementation.

FIG. 5 depicts a method of reducing the rate of turbulent combustion, according to an example implementation.

FIG. 6 depicts a method of providing an apparatus, according to an example implementation.

### DETAILED DESCRIPTION

Following below are more detailed descriptions of various concepts related to, and implementations of, methods, apparatuses, and systems of reducing the rate of turbulent combustion. The various concepts introduced above and discussed in greater detail below may be implemented in any of numerous ways.

The present disclosure is directed to systems and methods of reducing the rate of turbulent combustion. Combustible (or other) gas vented from a battery cell can mix with air located in a venting channel. These gases can have high temperatures when they are released from the battery cell and can ignite (e.g., combust) when they mix with the air. Mixing of the gases with air can occur in a turbulent manner (e.g., irregular, chaotic).

Systems and method of the present technical solution can provide an apparatus for reducing the rate of turbulent combustion. The apparatus can reduce the rate of turbulent combustion by reducing the turbulent mass diffusivity of the gas released from the battery cell. The apparatus can include a porous component located, for example, in the channel. The porous component can include a metal wool such as steel wool. The porous component can have pores each having a width that is less than a width of the channel. The mixing of the gas and the air can be less turbulent in a channel with the porous component located in the channel than in a channel without a porous component located in the channel. The thermal conductivity, surface-to-volume ratio, and the heat capacity of the porous component can be greater than the thermal conductivity, surface-to-volume ratio, and the heat capacity of the channel, respectively.

The disclosed solutions have a technical advantage of reducing or eliminating the combustion of gas vented from the battery cell with air. Additionally, the porous component can reduce hot spots in the channel and reduce the temperature of the gas vented from the battery. The porous component can be stable at temperatures at or above the temperature of the gas vented from the battery cells.

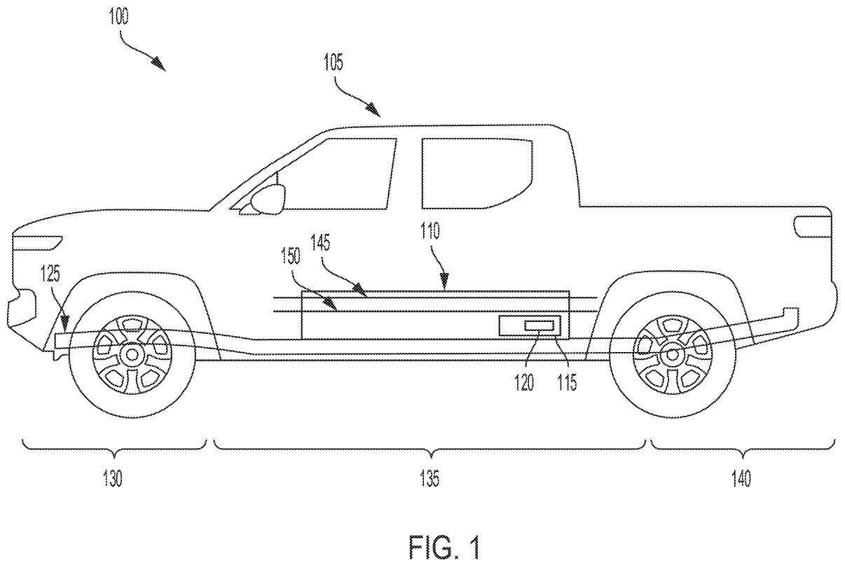

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

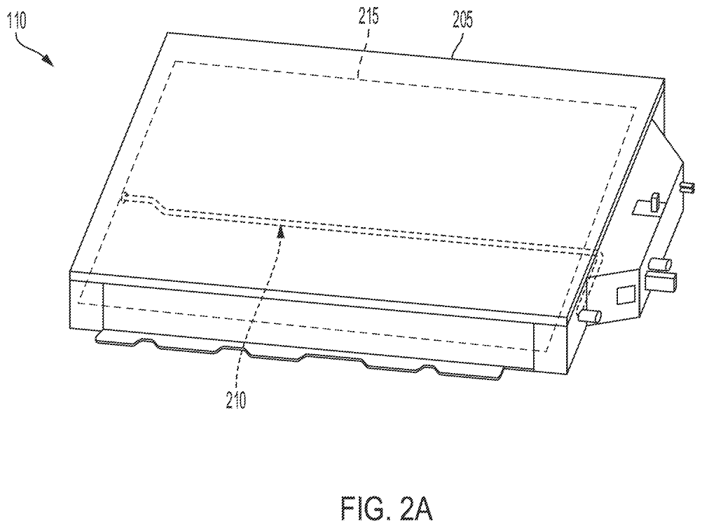

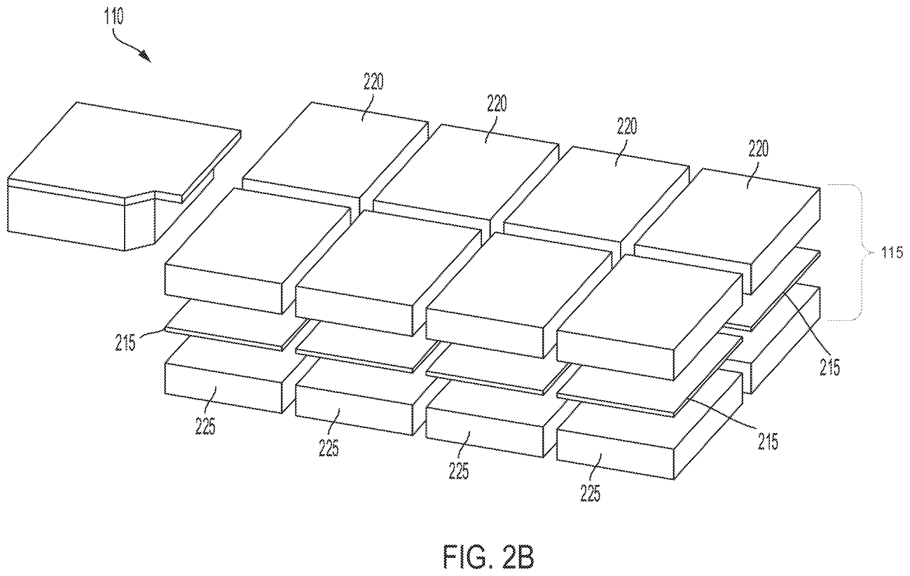

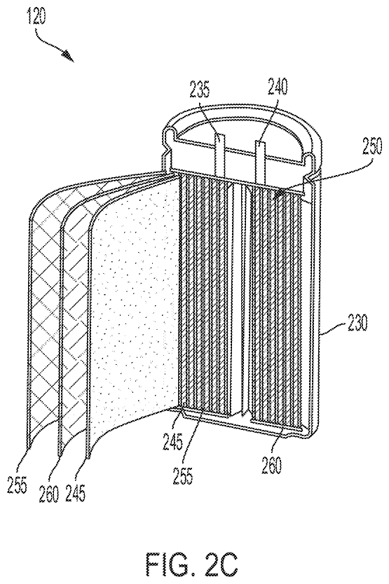

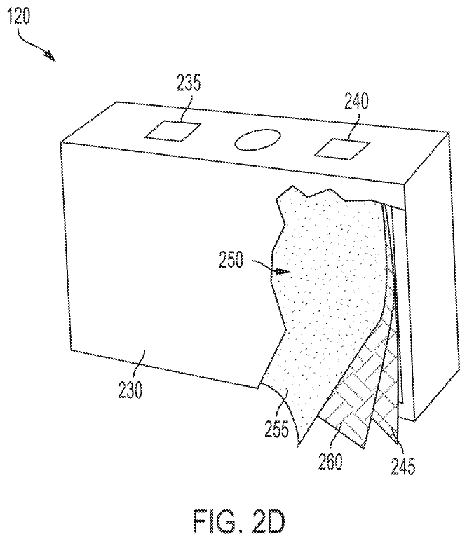

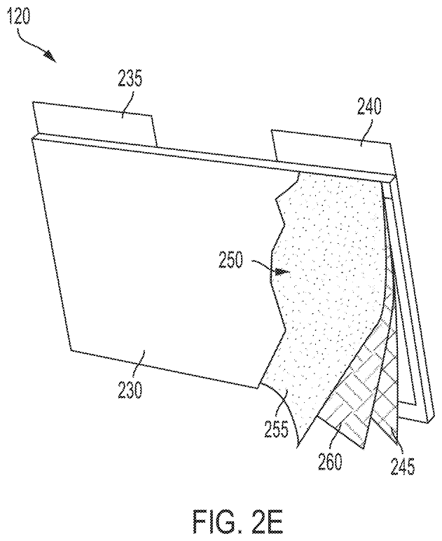

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIGS. 2C, 2D and 2E depict an example cross-sectional view of a battery cell 120. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery modules 220 and 225. The battery cells 120 can be disposed in the battery pack 110 in a cell-to-pack configuration without modules 220 and 225, among other possibilities.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. The battery cell 120 can also take the form of a solid state battery cell developed using solid electrodes and solid electrolytes. The solid state battery cell can include Li metal and a sulfide-based solid-state electrolyte. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery pack may not include modules. For example, the battery pack can have a cell-to-pack configuration wherein battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also receive lithium ions during the discharging of the battery cell 120. Conversely, the cathode layer 255 can receive electrical current into the battery cell 120 and can output electrons during the charging of the battery cell 120. The cathode layer 255 can release lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. The electrolyte layer 260 can transfer ions between the anode layer 245 and the cathode layer 255. The electrolyte layer 260 can transfer Li⁺ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example Lithium iron phosphate (LFP), lithium iron phosphate manganese (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

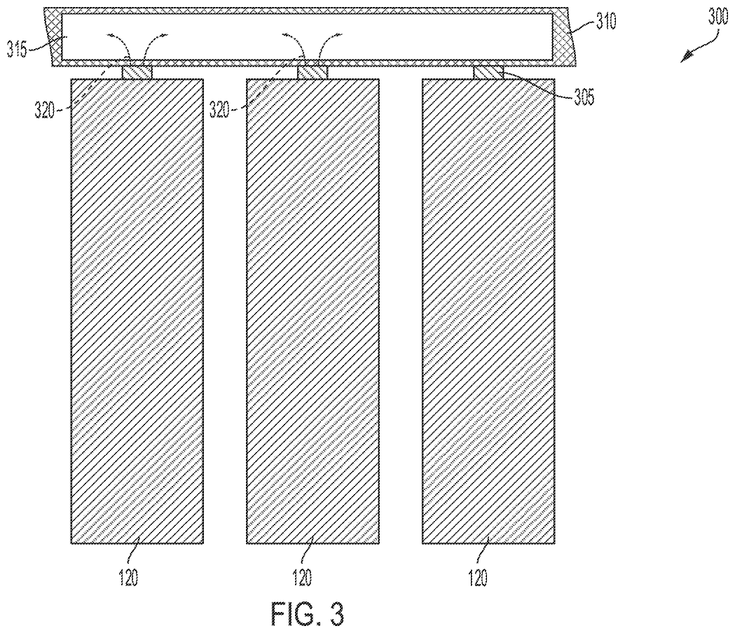

FIG. 3 depicts a perspective view of an apparatus 300. The apparatus can include at least one battery cell 120. The battery cell 120 can produce gas 320. The gas 320 can include hydrocarbons, hydrogen, water vapor, carbon dioxide, carbon monoxide, propane, ethane, methane, or combinations thereof. The gas 320 can include combustible gas or other gases. The gas 320 can include one or more combustible materials. The gas 320 can have a temperature in a range of 600° C. to 1000° C. For example, the gas 320 can be released from the battery cell 120 at a temperature in a range of 600° C. to 1000°.

The gas 320 can include hydrogen sulfide gas. The battery cell 120 can include a sulfide solid electrolyte disposed in the electric vehicle 105. Sulfide solid electrolytes or sulfur-containing cathodes can have chemical instability in air. For example, the PS₄³⁻ group can react with the humidity in the air (e.g., ambient humidity) and release corrosive H₂S gas. The battery cell 120 can include a sulfide-based solid electrolyte. For example, the battery cell 120 can include the sulfide-based solid electrolyte disposed in the electric vehicle 105. The battery cell 120 can include a sulfur-containing solid electrolyte. For example, the battery cell 120 can include the sulfur-containing solid electrolyte disposed in the electric vehicle 105. The battery cell 120 can include a lead acid battery with a liquid sulfuric acid electrolyte. The battery cell 120 can include a sulfur-containing cathode. For example, the battery cell 120 can include the sulfur-containing cathode disposed in the electric vehicle 105.

The hydrogen sulfide gas can be generated from at least one component of the battery cell 120. The component of the battery cell 120 can include a sulfur-containing solid electrolyte or a sulfur-containing cathode. For example, the component of the battery cell 120 can include an electrolyte (e.g., solid-state electrolyte, electrolyte layer 260). The hydrogen sulfide gas can be generated from a reaction between the component of the battery cell 120 and water. The hydrogen sulfide gas can be produced as a byproduct of the operation of the electric vehicle 105. The hydrogen sulfide gas can be produced by the electric vehicle 105. The hydrogen sulfide gas can be released from a component of the battery cell 120. The hydrogen sulfide gas can be produced from a lead acid battery cell 120. For example, the hydrogen sulfide gas can be produced from overcharging the lead acid battery cell 120. The hydrogen sulfide gas can be produced through a solid state electrolyte interaction with ambient humidity (e.g., water vapor surrounding the battery cell 120).

The battery cell 120 can include at least one vent 305. The vent 305 can be coupled with the battery cell 120. For example, the vent 305 can be fluidly coupled with the battery cell 120. The vent 305 can be attached to a top portion, a side portion, or a bottom portion of the battery cell 120. The gas 320 from the battery cell 120 can flow to the vent 305. The gas 320 from the battery cell 120 can flow through the vent 305. The gas 320 can have a temperature in a range of 600° C. to 1000° C. For example, the gas 320 can have a temperature in a range of 600° C. to 1000° C. as the gas 320 flows through the vent 305. The vent 305 can transport the gas 320 from the battery cell 120. For example, the vent 305 can transport the gas 320 having a temperature in a range of 600° C. to 1000° C.

The apparatus 300 can include at least one channel 310 (e.g., venting channel). The channel 310 can be coupled with the vent 305. For example, the channel 310 can be fluidly coupled with the vent 305. The channel 310 can be coupled with multiple vents 305. The vent 305 can be attached to a top portion, a side portion, or a bottom portion of the channel 310. The gas 320 can flow into the channel 310. For example, the gas 320 from the battery cell 120 can flow through the vent 305 into the channel 310. The gas 320 can have a temperature in a range of 600° C. to 1000° C. For example, the gas 320 can have a temperature in a range of 600° C. to 1000° C. as the gas 320 flows into the channel 310. The gas 320 can be ejected from the battery cell 120 into the channel 310.

The apparatus 300 can include at least one porous component 315. The porous component 315 can be disposed in the channel 310. For example, the porous component 315 can be disposed along a length of the channel 310. For example, the porous component 315 can fill or partially fill the channel 310. The porous component 315 can be disposed proximate to the battery cell 120. For example, the porous component 315 can contact the battery cell 120. The porous component 315 can be disposed inside or outside the battery cell 120. The porous component 315 can be disposed partially inside the vent or partially outside the battery cell 120. The porous component 315 can be external to the battery cell 120. The porous component 315 can be disposed at an ingress point of the battery cell 120 or an egress point of the battery cell 120. The porous component 315 can be within 10 mm of the battery cell 120. The porous component 315 can be disposed between a top surface of the battery cell 120 and a bottom surface of the battery cell 120. The porous component 315 can include an ordered structure (e.g., lattice). Increasing the surface area of the porous component 315 can increase the amount of gas absorption of the porous component 315. The gas 320 can be trapped in the porous component 315. The gas 320 can be trapped in the porous component 315 in the channel 310.

The porous component 315 can be coupled with the channel 310. For example, the porous component 315 can be secured (e.g., welded, pressure-fit) to the channel 310. The porous component 315 can include filaments. For example, the porous component 315 can include a fibrous matrix. The porous component 315 can include a foam (e.g., close-cell foam, open-cell foam). The porous component 315 can include metal wool. For example, the porous component 315 can include steel wool (e.g., stainless steel wool), iron wool, wire wool, bronze wool, aluminum wool, brass wool, copper wool, platinum wool, or other bundle or mesh of flexible metal filaments. The porous component 315 can include a phase change material. The porous component 315 can include at least one catalyst. For example, the porous component 315 can include a catalyst to convert carbon monoxide to carbon dioxide. The porous component 315 can decrease an amount of combustible material (e.g., CO) in the gas 320.

The porous component 315 can filter particles disposed in the vent 305 from the channel 310. For example, the porous component 315 can reduce or prevent particles from entering the channel 310 from the vent 305. The porous component 315 can reduce or prevent particles from entering the channel 310 from the battery cell 120. The particles can be produced by the battery cell 120. The vent 305 can receive particles form the battery cell 120. The particles can include carbon-based particles. The particles can include at least one of nickel, manganese, or copper. Particles from the battery cell 120 can flow through the vent 305 and mix with air in the channel 310. The particles can cause a short between the terminals of the battery cell 120 or between battery cells 120. Particles from the battery cell 120 can flow through the vent 305 and mix with gas in the channel 310.

The porous component 315 can be disposed proximate the vent 305. For example, the porous component 315 can contact the vent 305. The porous component 315 can be disposed inside or outside the vent 305. The porous component 315 can be disposed partially inside the vent 305 or partially outside the vent 305. The porous component 315 can be external to the vent 305. The porous component 315 can be disposed at an ingress point of the vent 305 or an egress point of the vent 305. The porous component 315 can be within 10 mm of the vent 305. The porous component 315 can be disposed between a top surface of the vent 305 and a bottom surface of the vent 305. For example, the porous component 315 can be disposed at the vent 305. The porous component 315 can be positioned at an opening of the vent 305. The porous component 315 can be positioned at the opening of the vent 305 and allow the gas 320 to flow from the battery cell 120 to the channel 310. The porous component 315 can be disposed in the vent 305. The gas 320 from the battery cell 120 can flow through the vent 305 and mix with air in the channel 310. For example, the gas 320 from the battery cell 120 can flow through the vent 305 and mix with air around the porous component 315 disposed in the channel 310. The gas 320 from the battery cell 120 can flow through the vent 305 and mix with gas in the channel 310. For example, the gas 320 from the battery cell 120 can flow through the vent 305 and mix with gases around the porous component 315 disposed in the channel 310. The gas 320 can mix with air or other gases in the channel 310 to produce gas that is benign. The porous component 315 can mix the gas 320 from the battery cell 120 with air in the channel 310. The porous component 315 can mix the gas 320 from the battery cell 120 with gas in the channel 310.

The porous component 315 can be coated with a coating (e.g., coating material). For example, the metal wool can be coated with the coating. An interior of the porous component 315 can be coated with the coating. For example, an interior of the metal wool can be coated with the coating. The coating can react with the gas 320. For example, the coating can react with hydrogen sulfide gas. The coating can react with the hydrogen sulfide gas to produce metal sulfide. The coating can react with the gas 320 to produce gas that is benign.

The hydrogen sulfide gas can be released in the battery pack 110 if there is a mechanical failure or cell (e.g., battery cell 120) failure. For example, an improper seal can let moisture (e.g., H₂O, water, etc.) into the battery pack 110. Moisture can be trapped in the battery cell 120 from an undried component of the battery cell 120, which can lead to battery cell failure. Hydrogen sulfide gas can corrode metal components in the battery pack 110. Hydrogen sulfide gas can corrode structural members of the battery pack 110. The porous component 315 can prevent the hydrogen sulfide gas from entering the cabin of the electric vehicle 105.

The melting point of the porous component 315 can be greater than the temperature of the gas 320. For example, the gas 320 can have a temperature in a range of 600° C. to 1000° C. The melting point of the porous component 315 can be greater than 600° C., greater than 700° C., greater than 800° C., greater than 900° C., or greater than 1000° C. For example, the melting point of the porous component 315 can be in a range of 1300° C.-1600° C. The porous component 315 can be a solid in the present of the gas 320. The melting point of the porous component 315 can be greater than the temperature of the gas 320 in the channel 310. The melting point of the porous component 315 can be greater than the temperature of the gas 320 as the gas 320 exits the vent 305. The porous component 315 can have a melting point greater than a melting point of the channel 310. The porous component 315 can have a melting point less than or equal to a thermal conductivity of the channel 310. The porous component 315 can have a melting point greater than a melting point of the gas 310. The porous component 315 can have a melting point less than or equal to a thermal conductivity of the gas 310.

The thermal conductivity of the porous component 315 can be greater than the thermal conductivity of the channel 310. The thermal conductivity of the channel 310 can be less than or equal to the thermal conductivity of the porous component 315. The porous component 315 can dissipate heat. The porous component 315 can act as a heat sink. Heat transfer can occur at a higher rate in the porous component 315 than in the channel 310. Heat transfer can occur at a lower rate in the channel 310 than in the porous component 315. The porous component 315 can have a thermal conductivity greater than a thermal conductivity of the channel 310. The porous component 315 can have a thermal conductivity less than or equal to a thermal conductivity of the channel 310.

The surface-to-volume ratio (e.g., surface-area-to-volume ratio, sa/vol, SA:V) of the porous component 315 can be greater than the surface-to-volume ratio of the channel 310. For example, the amount of surface area per unit volume of the porous component 315 can be greater than the amount of surface area per unit volume of the channel 310. The surface-to-volume ratio of the channel 310 can be less than the surface-to-volume ratio of the porous component 315. For example, the amount of surface area per unit volume of the channel 310 can be less than the amount of surface area per unit volume of the porous component 315. The porous component 315 can have a surface-to-volume ratio greater than a surface-to-volume ratio of the channel 310. The porous component 315 can have a surface-to-volume ratio less than or equal to a surface-to-volume ratio of the channel 310.

The heat capacity (e.g., thermal capacity) of the porous component 315 can be greater than the heat capacity of the channel 310. The amount of heat to be supplied to the porous component 315 to produce a unit change in the temperature of the porous component 315 can be greater than the amount of heat to be supplied to the channel 310 to produce a unit change in the temperature of the channel 310. The heat capacity of the channel 310 can be less than the heat capacity of the porous component 315. The amount of heat to be supplied to the channel 310 to produce a unit change in the temperature of the channel 310 can be less than the amount of heat to be supplied to the porous component 315 to produce a unit change in the temperature of the porous component 315.

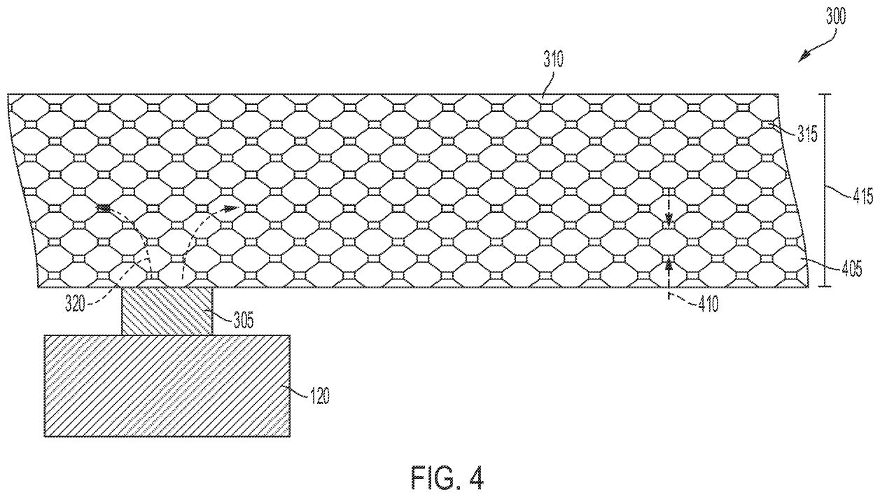

FIG. 4 depicts a perspective view of the apparatus 300. The apparatus 300 can include the battery cell 120. The apparatus 300 can include the vent 305. The apparatus 300 can include the channel 310. The apparatus 300 can include the porous component 315. The apparatus 300 can include the gas 320.

The porous component 315 can include at least one pore 405 (e.g., one or more pores). Each pore 405 can have a width (e.g., pore width 410, pore diameter). The pore width 410 can be uniform or varying. The channel 310 can have a width (e.g., channel width 415). Turbulent mass diffusivity, Dₜ, can be affected by the mixing length, lₘ. Turbulent mass diffusivity can be a function of the geometry where fluid (e.g., gas 320) flows. According to the definition of turbulent Schmidt number (Scₜ) and the mixing length theory, turbulent mass diffusivity can be expressed by Equation 1:

Dₜ=lₘ²Scₜ|∂y/∂y| (1)

In a system (e.g., apparatus) without the porous component 315, the mixing length can include the channel width 415. In the system without the porous component 315, the mixing length can be on the order of the channel width 415. In a system with the porous component 315, the mixing length can include the pore width 410. In the system with the porous component 315, the mixing length can be on the order of the pore width 410.

Each pore 405 can have the pore width 410 less than the channel width 415. For example, each pore 405 of the one or more pores can have a width less than the width of the channel 310. The pore width 410 can be less than the channel width 415. The pore width 410 can be lower than a threshold (e.g., channel width 415). The pore width 410 can be less than 10% of the channel width 415. For example, the width of each of the one or more pores can be less than 10% of the width of the channel 310.

The battery cell 120 can include a first battery cell 120. The vent 305 can include a first vent 305. The porous component 315 can include a first porous component 315. The first porous component 315 can be disposed proximate the first vent 305. For example, the porous component 315 can contact the first vent 305. The porous component 315 can be disposed inside or outside the first vent 305. The porous component 315 can be disposed partially inside the first vent 305 or partially outside the first vent 305. The porous component 315 can be external to the first vent 305. The porous component 315 can be disposed at an ingress point of the first vent 305 or an egress point of the first vent 305. The porous component 315 can be within 10 mm of the first vent 305. The porous component 315 can be disposed between a top surface of the first vent 305 and a bottom surface of the first vent 305. The apparatus 300 can include a second battery cell 120. The second battery cell 120 can include a second vent 305. The vent 305 can be coupled with the second battery cell 120 and the channel 310. The second battery cell 120 can be disposed a distance from the first battery cell 120.

The apparatus 300 can include a second porous component 315 disposed in the channel 310. The second porous component 315 can include at least one pore 405. Each pore 405 can have a width less than the width of the channel 310. The second porous component 315 can be disposed proximate the second vent 305. For example, the porous component 315 can contact the second vent 305. The porous component 315 can be disposed inside or outside the second vent 305. The porous component 315 can be disposed partially inside the second vent 305 or partially outside the second vent 305. The porous component 315 can be external to the second vent 305. The porous component 315 can be disposed at an ingress point of the second vent 305 or an egress point of the second vent 305. The porous component 315 can be within 10 mm of the second vent 305. The porous component 315 can be disposed between a top surface of the second vent 305 and a bottom surface of the second vent 305. The second porous component 315 can be the same as or different from the first porous component 315.

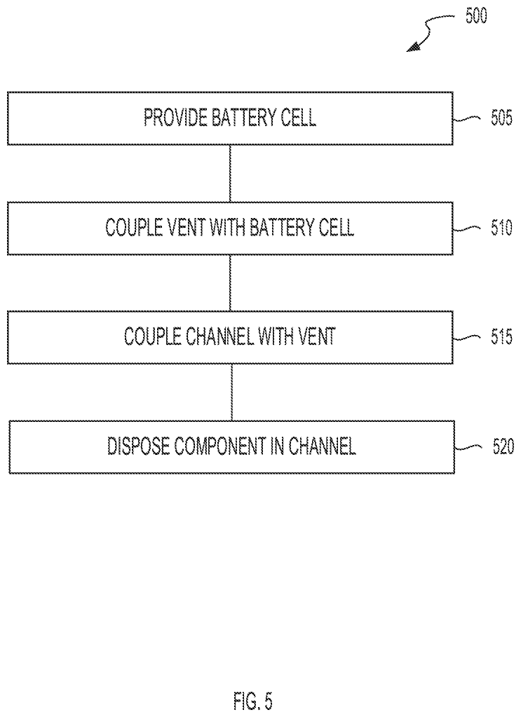

FIG. 5 depicts a method 500 of reducing the rate of turbulent combustion. The method 500 can include providing the battery cell 120 (ACT 505). The method 500 can include coupling the vent 305 with the battery cell 120 (ACT 510). The method 500 can include coupling the channel 310 with the vent 305. (ACT 515). The method 500 can include disposing a component in the channel 310 (ACT 520).

The method 500 can include providing the battery cell 120 (ACT 505). The battery cell 120 can include one or more materials with various electrical conductivity or thermal conductivity, or a combination thereof. The battery cell 120 can include the anode layer 245. The battery cell 120 can include the cathode layer 255. The battery cell 120 can include the electrolyte layer 260 disposed within the cavity 250. The battery cell 120 can produce the gas 320.

The method 500 can include coupling the vent 305 with the battery cell 120 (ACT 510). For example, the method 500 can include fluidly coupling the vent 305 with the battery cell 120. The vent 305 can be attached to a top portion, a side portion, or a bottom portion of the battery cell 120. The gas 320 from the battery cell 120 can flow to the vent 305. The gas 320 from the battery cell 120 can flow through the vent 305. The gas 320 can have a temperature in a range of 600° C. to 1000° C. For example, the gas 320 can have a temperature in a range of 600° C. to 1000° C. as the gas 320 flows through the vent 305.

The method 500 can include coupling the channel 310 with the vent 305. (ACT 515). For example, the method 500 can include fluidly coupling the channel 310 with the vent 305. The channel 310 can be coupled with multiple vents 305. The vent 305 can be attached to a top portion, a side portion, or a bottom portion of the channel 310. The gas 320 can flow into the channel 310. For example, the gas 320 from the battery cell 120 can flow through the vent 305 into the channel 310. The gas 320 can have a temperature in a range of 600° C. to 1000° C. For example, the gas 320 can have a temperature in a range of 600° C. to 1000° C. as the gas 320 flows into the channel 310. The gas 320 can be ejected from the battery cell 120 into the channel 310. The gas 320 can mix with air or other gases in the channel 310. The gas 320 can mix and react with air or other gases in the channel 310 to produce gas that is benign.

The method 500 can include disposing a component in the channel 310 (ACT 520). For example, the method 500 can include disposing the porous component 315 in the channel 310. For example, the method 500 can include disposing the porous component 315 along a length of the channel 310. For example, the porous component 315 can fill or partially fill the channel 310. The porous component 315 can be disposed proximate to the battery cell 120. For example, the porous component 315 can contact the battery cell 120. The porous component 315 can be disposed inside or outside the battery cell 120. The porous component 315 can be disposed partially inside the vent or partially outside the battery cell 120. The porous component 315 can be external to the battery cell 120. The porous component 315 can be disposed at an ingress point of the battery cell 120 or an egress point of the battery cell 120. The porous component 315 can be within 10 mm of the battery cell 120. The porous component 315 can be disposed between a top surface of the battery cell 120 and a bottom surface of the battery cell 120. The porous component 315 can be coupled with the channel 310. For example, the porous component 315 can be secured (e.g., welded, pressure-fit) to the channel 310. The porous component 315 can include filaments. For example, the porous component 315 can include a fibrous matrix. The porous component 315 can include a foam (e.g., close-cell foam, open-cell foam). The porous component 315 can include metal wool. For example, the porous component 315 can include steel wool (e.g., stainless steel wool), bronze wool, aluminum wool, brass wool, copper wool, platinum wool, among others. The porous component 315 can include a phase change material. The porous component 315 can include at least one catalyst. For example, the porous component 315 can include a catalyst to convert carbon monoxide to carbon dioxide. The porous component 315 can decrease an amount of combustible material (e.g., CO) in the gas 320. The porous component 315 can include a catalyst to convert hydrogen sulfide to metal sulfide. The porous component 315 can filter particles disposed in the vent 305 from the channel 310.

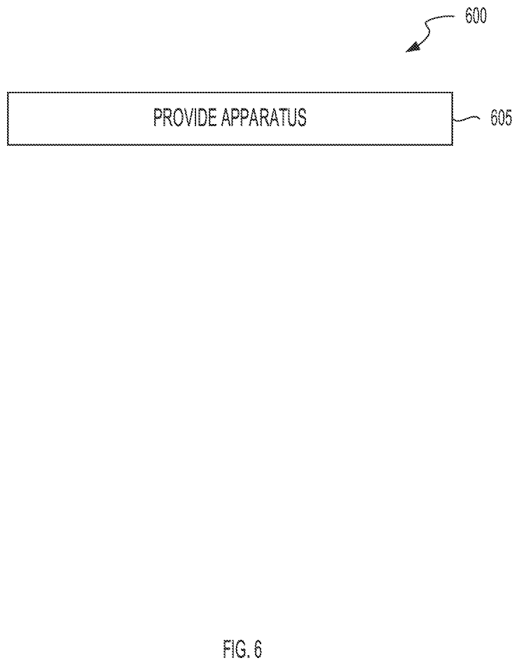

FIG. 6 depicts a method 600 of providing the apparatus 300 (ACT 605). The apparatus 300 can include the battery cell 120. The battery cell 120 can include the vent 305 coupled with the battery cell 120. The apparatus 300 can include the channel 310. The channel 310 can be coupled with the vent 305. The apparatus 300 can include the porous component 315. The porous component 315 can be disposed in the channel 310. The porous component 315 can include one or more pores 405 each having a width less than a width of the channel 310.

The electric vehicle 105 can include the battery cell 120. The battery cell 120 can include the vent 305 coupled with the battery cell 120. The electric vehicle 105 can include the channel 310. The channel 310 can be coupled with the vent 305. The electric vehicle 105 can include the porous component 315. The porous component 315 can be disposed in the channel 310. The porous component 315 can include one or more pores 405 each having a width less than a width of the channel 310.

The system can include the battery cell 120. The battery cell 120 can include the vent 305 coupled with the battery cell 120. The system can include the channel 310. The channel 310 can be coupled with the vent 305. The system can include the porous component 315. The porous component 315 can be disposed in the channel 310. The porous component 315 can include one or more pores 405 each having a width less than a width of the channel 310.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and 13′ can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a battery cell comprising a vent coupled with the battery cell;
a channel coupled with the vent; and
a porous component disposed in the channel, the porous component comprising one or more pores each having a width less than a width of the channel.

2. The apparatus of claim 1, wherein the porous component comprises metal wool.

3. The apparatus of claim 1, comprising:
the porous component configured to mix gas from the battery cell with air in the channel.

4. The apparatus of claim 1, comprising:
the width of each of the one or more pores is less than 10% of the width of the channel.

5. The apparatus of claim 1, comprising:
the porous component having a thermal conductivity greater than a thermal conductivity of the channel.

6. The apparatus of claim 1, comprising:
the battery cell configured to produce gas comprising hydrocarbons, hydrogen, water vapor, carbon dioxide, carbon monoxide, propane, ethane, methane, or a combination thereof.

7. The apparatus of claim 1, wherein particles from the battery cell are configured to flow through the vent and mix with air in the channel.

8. The apparatus of claim 1, comprising:
the vent configured to transport gas from the battery cell, the gas having a temperature in a range of 600° C. to 1000° C.

9. The apparatus of claim 1, comprising:
the porous component having a surface-to-volume ratio greater than a surface-to-volume ratio of the channel.

10. The apparatus of claim 1, comprising:
the porous component having a heat capacity greater than a heat capacity of the channel.

11. The apparatus of claim 1, comprising:
the porous component configured to filter particles disposed in the vent from the channel.

12. The apparatus of claim 1, wherein the porous component comprises a catalyst configured to convert at least one of carbon monoxide to carbon dioxide or hydrogen sulfide to metal sulfide.

13. The apparatus of claim 1, comprising:
the porous component disposed between a top surface of the vent and a bottom surface of the vent.

14. The apparatus of claim 1, wherein the porous component comprises filaments.

15. The apparatus of claim 1, comprising:
the vent configured to transport gas from the battery cell through the vent; and
the porous component having a melting point that is greater than a temperature of the gas.

16. The apparatus of claim 1, wherein the battery cell is a first battery cell, the vent is first vent, and the porous component is a first porous component, the apparatus comprising:
the first porous component configured to contact the first vent;
a second battery cell comprising a second vent coupled with the second battery cell and the channel, the second battery cell disposed a distance from the first battery cell;
a second porous component disposed in the channel, the second porous component comprising one or more pores each having a width less than the width of the channel; and
the second porous component configured to contact the second vent.

17. A method, comprising:
coupling a vent with a battery cell;
coupling a channel with the vent; and
disposing a porous component in the channel, the porous component comprising one or more pores each having a width less than a width of the channel.

18. The method of claim 17, comprising:
flowing gas from the battery cell through the vent; and
mixing the gas with air in the channel.

19. The method of claim 17, comprising:
filtering, by the porous component, particles disposed in the vent from the channel.

20. An electric vehicle, comprising:
a battery cell comprising a vent coupled with the battery cell;
a channel coupled with the vent; and
a porous component disposed in the channel, the porous component comprising one or more pores each having a width less than a width of the channel.
